(19) United States
(12) Patent Application Publication
(10) Pub. No.: US 2026/0137105 A1
(43) Pub. Date: May 21, 2026

(54) METHOD FOR PREPARING PEAR JUICE WITH ENHANCED ANTIOXIDANT EFFECTS

(71) Applicant: GOOD F&B, Naju-si (KR)

(72) Inventor: Ki Sun LEE, Naju-si (KR)

(21) Appl. No.: 19/228,978

(22) Filed: Jun. 5, 2025

Related U.S. Application Data
(60) Provisional application No. 63/720,996, filed on Nov. 15, 2024.

(51) Int. Cl. A23L 2/04; A23B 70/30; A23L 19/00

(52) U.S. Cl. CPC A23L 2/04; A23B 70/30; A23L 19/09

(57) ABSTRACT

The present invention relates to a method for preparing pear juice with enhanced antioxidant activity and the pear juice prepared by the method. More specifically, the invention provides a method for preparing pear juice in which steaming is performed at a specific temperature for a predetermined period of time, resulting in increased total polyphenol and flavonoid contents, as well as enhanced antioxidant activity, and also relates to pear juice with improved antioxidant efficacy prepared by the method.

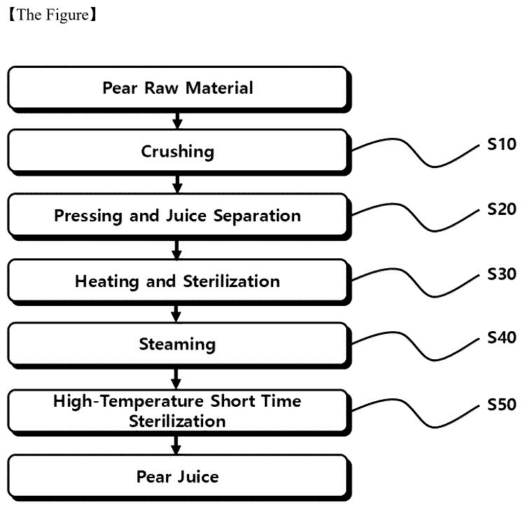

### TECHNICAL FIELD

The present invention relates to a method for preparing pear juice with enhanced antioxidant activity. More particularly, the invention pertains to a method of preparing pear juice in which steaming is performed at a specific temperature for a predetermined period of time, resulting in an increase in the total polyphenol and flavonoid contents, as well as improved antioxidant efficacy as demonstrated by enhanced DPPH and ABTS radical scavenging activity.

### BACKGROUND ART

Antioxidation refers to the process of protecting the body from oxidative stress. Oxidative stress is caused by oxidants, which are reactive species that naturally arise during normal metabolic processes such as energy production using nutrients and immune responses that destroy invading bacteria and viruses. These oxidants are highly unstable and, when produced or accumulated in excess, can damage DNA and cells, ultimately leading to aging and chronic diseases. However, the human body is equipped with an antioxidant system that eliminates such oxidants, thereby minimizing harmful effects.

Nonetheless, when the balance between the generation and removal of oxidants is disrupted due to aging, psychological or environmental stress, disease, or metabolic imbalance, oxidative stress becomes problematic. Therefore, in order to enhance quality of life and maximize lifespan, a robust antioxidant system that protects the body from oxidative stress is essential.

One of the most representative oxidants that induce oxidative stress is reactive oxygen species (ROS). Oxygen, which enters the body through respiration, is used to convert nutrients into energy, and during this process, ROS are generated. These ROS are highly reactive and can damage nearby cells and tissues.

Cells attacked by oxidative stress may lose function or undergo alteration. Loss of cellular function translates to a decline in the body's ability to function properly. If ROS are not neutralized by the body's defense mechanisms, they can rapidly react with biomolecules, causing protein denaturation, lipid peroxidation of cellular membranes, DNA damage, and enzyme inactivation. Lipid peroxides that spread intracellularly or via the bloodstream can promote the generation of new ROS, accelerating the progression of cancer, cardiovascular disease, rheumatoid arthritis, inflammation, and aging. For example, excessive ROS can react with lipids to form lipid peroxides, which can induce thrombosis and embolism in blood vessels, destroy vascular structures, and obstruct blood flow to peripheral cells, leading to circulatory disorders. When such damage occurs in the brain, it may result in stroke, cerebral hemorrhage, or cerebral thrombosis; in the heart, myocardial infarction; and in arteries, atherosclerosis. In the skin, ROS-derived lipid peroxides can damage the stratum corneum and moisture barrier, resulting in degradation of the skin surface.

Accordingly, various antioxidants capable of eliminating ROS have been developed. These antioxidants are mostly derived from natural plants such as fruits, vegetables, and grains. Humans consume these in various ways to protect the body from oxidative stress.

Pears (Pyrus pyrifolia var. culta, commonly known as Korean pears) are the fruit of the pear tree. They have a slightly yellowish peel, white and firm flesh, and a sweet flavor. Due to their crisp texture, refreshing sweetness, and abundant juice content, pears have long been one of Korea's staple fruits. Korean pears are rich in organic acids and vitamins and have high dietary fiber content, making them effective for constipation relief and intestinal regulation. With a sugar content of approximately 10-13%, they can be used as a sugar substitute for diabetic patients.

Although Korean pears are mainly consumed as fresh fruit, useful substances are also present in the peel and seeds, which are typically discarded. Some studies have been conducted to utilize these pear by-products. For example, Korean Patent No. 10-1439321 discloses a pear solid fermentation liquid produced by fermenting pear pomace, which is obtained as a by-product during the juice extraction step of a clear pear juice manufacturing process, using yeast, lactic acid bacteria, or enzymes, and further discloses its application in the preparation of pear-based alcoholic beverages such as pear makgeolli (traditional Korean rice wine). In addition, Korean Patent No. 10-1506296 discloses a scrub cosmetic composition comprising pear sclereids, which provides advantages such as being non-irritating to the skin, offering a pleasant sensory experience during use, and exhibiting uniform and excellent exfoliation and pore-reducing effects. The patent further discloses that the pear sclereids are used as scrubbing particles, and that the intensity of the scrubbing action can be adjusted depending on the size of the sclereid particles. Furthermore, Korean Patent No. 10-2137470 discloses an antioxidant and anti-inflammatory composition comprising an extract of pear processing by-products. The extract is obtained by mixing the solid by-products-containing pear peel, core, and flesh-generated during the juice extraction process with water, subjecting the mixture to hot water extraction, and subsequently concentrating the extract under reduced pressure.

However, conventional technologies focus on processing pear flesh, thereby failing to utilize the beneficial components present in the peel and seeds simultaneously when only the flesh is used.

To address this, the inventors of the present invention developed a method for preparing pear juice that includes the peel and seeds, which contain high levels of bioactive compounds. They further discovered that incorporating a steaming process during juice preparation significantly enhances the antioxidant activity of the pear juice, leading to the completion of the present invention.

### DETAILED DESCRIPTION OF THE INVENTION

### Technical Problem

Therefore, one object of the present invention is to provide a method for preparing pear juice with enhanced antioxidant activity.

In addition, another object of the present invention is to provide pear juice with enhanced antioxidant activity, prepared by the above-mentioned method.

### Technical Solution

As one aspect, the present invention provides a method for preparing pear juice with enhanced antioxidant activity.

As a specific aspect, the method for preparing pear juice with enhanced antioxidant activity according to the present invention comprises the steps of:
(S10) crushing raw pears including the peel and seeds;
(S20) pressing the crushed pears to separate the juice from the solids;
(S30) subjecting the separated juice to heat sterilization; and
(S40) steaming the heat-sterilized pear juice.

In the present invention, the term “pear” refers to the fruit of Pyrus pyrifolia var. culta, commonly known as Korean pear.

In the present invention, “antioxidation” refers to the action of protecting an organism from oxidative stress caused by reactive oxygen species (ROS).

In the present invention, “antioxidant activity” refers to the suppression of oxidative stress by eliminating reactive oxygen species. The antioxidant activity may be measured by various methods known in the art to which the present invention pertains, but preferably, it may be determined by the DPPH radical scavenging activity assay and/or the ABTS radical scavenging activity assay. These assays may be carried out with reference to known publications such as Mechanisms of Free Radical Generation and Scavenging (Jong-Deok Kim, Chonnam National University Press, 2013), or according to the methods described herein.

In the present invention, the “enhancement of antioxidant activity” refers to an increase in antioxidant activity, as measured by various methods known in the relevant technical field, preferably by the DPPH radical scavenging activity assay and/or the ABTS radical scavenging activity assay, relative to a control group.

In one specific embodiment, the pear juice prepared according to the present invention exhibits an antioxidant activity, as measured by the DPPH radical scavenging activity assay, that is increased by 20%, 21%, 22%, 23%, 24%, 25%, 26%, 27%, 28%, 29%, 30%, or more, compared to the control group. The increase may also fall within a range defined by any two of the foregoing values, for example, from 20% to 30%, from 21% to 30%, from 22% to 30%, from 24% to 30%, from 25% to 30%, or from 20% to 29%.

In another specific embodiment, the pear juice prepared according to the present invention exhibits an antioxidant activity, as measured by the ABTS radical scavenging activity assay, that is increased by 6%, 7%, 8%, 9%, 10%, 11%, 12%, 13%, 14%, 15%, or more, compared to the control group. The increase may also fall within a range defined by any two of the foregoing values, for example, from 6% to 15%, from 7% to 15%, from 8% to 15%, from 9% to 15%, from 8% to 14%, or from 8% to 13%.

In addition, in the present invention, the enhancement of antioxidant activity may also refer to an increase in the total phenolic content and/or total polyphenol content contained in the pear juice, relative to a control group. The total phenolic content and/or total polyphenol content may be measured using known methods, such as the test methods specified in the Health Functional Food Code issued by the Ministry of Food and Drug Safety of Korea, or other methods described in this specification.

In one specific embodiment, the total phenolic content of the pear juice prepared according to the present invention may be increased by 40%, 41%, 42%, 43%, 44%, 45%, 46%, 47%, 48%, 49%, 50%, or more, compared to a control group. The increase may also fall within a range defined by any two of the aforementioned values, for example, from 40% to 50%, from 41% to 50%, from 42% to 50%, from 43% to 49%, or from 44% to 48%.

In another specific embodiment, the total flavonoid content of the pear juice prepared according to the present invention may be increased by 40%, 41%, 42%, 43%, 44%, 45%, 46%, 47%, 48%, 49%, 50%, or more, compared to a control group. The increase may also fall within a range defined by any two of the aforementioned values, for example, from 40% to 50%, from 41% to 50%, from 42% to 50%, from 42% to 49%, from 42% to 48%, or from 42% to 47%.

In the present invention, the control group may be pear juice prepared through steps (S10) to (S30) of the method for preparing pear juice described herein.

In the present invention, the term “enhancement” is used interchangeably with “increase” or “boost,” and the term “decrease” is used interchangeably with “inhibition” or “reduction.”

Hereinafter, with reference to the FIGURE, a method of preparing pear juice with enhanced antioxidant activity according to the present invention will be specifically described.

First, Step (S10) is a step of crushing raw pears including the peel and seeds. Specifically, this step entails crushing the whole raw pear material without removing the peel or seeds.

The pear peel (pericarp) serves to protect the seeds from external environments and may be classified into the epicarp (outer pericarp), mesocarp (middle pericarp), and endocarp (inner pericarp). The epicarp refers to the outermost layer of the fruit and is commonly known as the skin or peel. The mesocarp constitutes the flesh of the pear, and the endocarp is the innermost layer surrounding the seeds.

Step (S10) is characterized in that not only the mesocarp, preferably the pear flesh, is used for juice extraction, but also the entire pear, including the epicarp, endocarp, and seeds, is utilized. This enables the incorporation of beneficial components contained in the epicarp, endocarp, and seeds into the resulting pear juice.

The crushing may be carried out to a particle size suitable for the subsequent juice extraction step (S20). For example, the maximum dimension (length, width, or height) of the crushed particles may be 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, or fall within any range between two of the aforementioned values, such as 2 to 20 mm, 2 to 15 mm, 2 to 10 mm, 2 to 8 mm, 3 to 8 mm, 4 to 8 mm, 4 to 7 mm, or 4 to 6 mm.

The crushing may be performed using a suitable fruit crusher, such as a blender or a roll crusher, to the desired particle size and for an appropriate duration.

In some embodiments, a washing step may be additionally included before the crushing step. The washing step is performed to remove foreign matter adhered to the raw pear material and may be conducted using conventional methods such as running water washing or bubble washing.

Step (S20) is a step of pressing the crushed pears to separate and obtain only the juice. More specifically, this step refers to the step of producing pear juice by extracting only the liquid portion from the crushed material obtained in step (S10).

The pressing is performed by applying pressure to the crushed pear material obtained in step (S10) to separate the liquid component. This pressing may be carried out at room temperature, but preferably at a temperature lower than room temperature, more preferably at a temperature in the range of 0 to 20° C., even more preferably 0 to 15° C., still more preferably 5 to 15° C., and most preferably 5 to 10° C. Performing the juice extraction at room temperature or, preferably, at a lower temperature helps prevent thermal degradation of the nutrients contained in the pear.

The pressing may be performed for a period sufficient to achieve effective juice extraction, for example, for about 5 to 20 minutes.

After pressing, only the juice is separated. The separation of juice may be achieved using a filtration mesh, specifically with a pore diameter of 0.1 mm, 0.2 mm, 0.3 mm, 0.4 mm, 0.5 mm, 0.6 mm, 0.7 mm, or 0.8 mm. Preferably, a filtration mesh having a pore diameter in the range of 0.1 to 0.8 mm, more preferably 0.2 to 0.7 mm, even more preferably 0.2 to 0.6 mm, still more preferably 0.2 to 0.5 mm, even further preferably 0.2 to 0.4 mm, and most preferably 0.3 mm may be used.

If the pore size of the filtration mesh is less than 0.1 mm, the separation of the juice may be insufficient, resulting in a low yield of the extracted juice, which is economically disadvantageous. On the other hand, if the pore size of the filtration mesh exceeds 0.8 mm, visually large particles and crushed seed fragments may be included in the juice. Although this does not affect the quality of the juice, it may cause undesirable visual discomfort. Accordingly, the mesh serves to filter only the pear juice, while larger components such as sclereids, coarse residues, and seeds with particle sizes exceeding 0.8 mm remain as by-products.

Step (S30) is a step of subjecting the separated juice to heat sterilization.

The heat sterilization may be carried out at a high temperature, preferably in the range of 80 to 90° C., more preferably 82 to 88° C., even more preferably 84 to 86° C., and most preferably at 85° C., for a duration of 2 to 4 hours, preferably 2.5 to 3.5 hours, more preferably 2.8 to 3.2 hours, and most preferably for 3 hours.

If the steam sterilization is performed at a temperature lower than 80° C. and/or for less than 2 hours, the desired effects described above may not be achieved. Conversely, the steam sterilization at a temperature exceeding 90° C. and/or for more than 4 hours may result in compositional changes in the separated pear juice, potentially degrading its flavor or reducing its antioxidant activity.

Step (S40) is a step of steaming the heat-sterilized pear juice.

The steaming may be performed by holding the juice at a constant high temperature for a predetermined period of time. The temperature may be 80° C., 81° C., 82° C., 83° C., 84° C., 85° C., 86° C., 87° C., 88° C., 89° C., or 90° C., or within a range defined by any two of the aforementioned values, for example, 80 to 90° C., 81 to 90° C., or 82 to 89° C. The duration may be 10 hours, 11 hours, 12 hours, 13 hours, or 14 hours, or within a range defined by any two of the aforementioned values, for example, 10 to 14 hours, 11 to 14 hours, 12 to 14 hours, or 10 to 13 hours.

If the steaming temperature is below 80° C., the increase in antioxidant components and/or antioxidant activity of the pear juice may be minimal. On the other hand, if the temperature exceeds 90° C., antioxidant components in the pear juice may undergo undesirable alterations, leading to reduced antioxidant activity.

In addition, if the steaming duration is less than 10 hours, the enhancement in antioxidant components and/or activity may be insignificant. If the duration exceeds 14 hours, further improvement is not observed, resulting in economic inefficiency.

Through the steaming step, the antioxidant activity of the pear juice can be increased by 18, 2%, 3%, 4%, 5%, 6%, 7%, 8%, 9%, or 10% or more compared to the non-steamed juice. The criteria for evaluating antioxidant activity enhancement are as described above.

In some embodiments, after step (S40), the method may further comprise step (S50), in which the steamed pear juice is subjected to ultra-high temperature (UHT) short-time sterilization.

The UHT short-time sterilization involves exposing the steamed juice to high heat for a very short period of time, specifically 1 minute or less, in order to prevent contamination, spoilage, or deterioration caused by external microorganisms that may occur during the steaming process in step (S40) or during transfer prior to step (S50). This step is intended to ensure the microbiological safety of the pear juice.

The short exposure time may be 1 minute or less, for example, 20 seconds, 30 seconds, 40 seconds, 50 seconds, or 60 seconds. Preferably, the treatment may be performed within a range of 20 to 60 seconds, more preferably 20 to 50 seconds, 20 to 40 seconds, 20 to 30 seconds, or 30 to 40 seconds.

The high temperature used in this step may be greater than the temperature applied during the heat sterilization of step (S30), and is preferably 100° C. or higher, more preferably in the range of 100 to 130° C., even more preferably 110 to 130° C., and most preferably 118 to 125° C.

After step (S40) or step (S50), the method may further comprise step (S60), in which the pear juice is packaged. The packaging is preferably carried out using a light-shielding material and may be in a form suitable for convenient consumption, such as a pouch or container.

In addition, after the steaming of the heat-sterilized pear juice in step (S40), a filtration step may further be performed to filter the steamed product. Similarly, after the ultra-high temperature short-time sterilization in step (S50), a filtration step may also be additionally performed to filter the sterilized product. Preferably, the filtration in these steps is carried out using a filtration mesh having a smaller pore size than that used in step (S20).

In one embodiment, the filtration of the steamed product from step (S40) may be performed using a microfilter, preferably having a pore size of 3 to 10 μm, more preferably 3 to 7 μm, even more preferably 4 to 6 μm, and most preferably 5 μm.

In another embodiment, the filtration of the sterilized product from step (S50) may be performed using a mesh screen, preferably a 90 to 110 mesh screen, more preferably a 95 to 105 mesh screen, even more preferably a 98 to 102 mesh screen, and most preferably a 100 mesh screen.

Through such filtration, foreign substances that may remain in the steamed product and/or the UHT-sterilized steamed product can be removed, thereby reducing any foreign body sensation caused by non-liquid residues during consumption and improving the palatability of the pear juice.

As another aspect, the present invention provides pear juice with enhanced antioxidant activity, prepared by the above-described method.

The pear juice according to the present invention exhibits improved antioxidant activity compared to pear juice prepared by different methods, such as juice that has been heat-sterilized but not subjected to steaming. Specifically, the antioxidant activity may be increased by 1%, 2%, 3%, 4%, 5%, 6%, 7%, 8%, 9%, or 10% or more compared to pear juice that has been only heat-sterilized without undergoing the steaming process.

In one specific example, the pear juice according to the present invention may exhibit an antioxidant activity, as measured by the DPPH radical scavenging activity assay, that is increased by 20%, 21%, 22%, 23%, 24%, 25%, 26%, 27%, 28%, 29%, 30%, or more compared to pear juice that has been heat-sterilized only and not subjected to steaming. The increase may also fall within a range defined by any two of the foregoing values, for example, from 20% to 30%, from 21% to 30%, from 22% to 30%, from 24% to 30%, from 25% to 30%, or from 20% to 29%.

In another specific example, the pear juice according to the present invention may exhibit an antioxidant activity, as measured by the ABTS radical scavenging activity assay, that is increased by 6%, 7%, 8%, 9%, 10%, 11%, 12%, 13%, 14%, 15%, or more compared to pear juice that has been heat-sterilized only and not subjected to steaming. The increase may also fall within a range defined by any two of the foregoing values, for example, from 6% to 15%, from 7% to 15%, from 8% to 15%, from 9% to 15%, from 8% to 14%, or from 8% to 13%.

In another specific example, the total phenolic content of the pear juice according to the present invention may be increased by 40%, 41%, 42%, 43%, 44%, 45%, 46%, 47%, 48%, 49%, 50%, or more compared to pear juice that has been heat-sterilized only and not subjected to steaming. The increase may also fall within a range defined by any two of the foregoing values, for example, from 40% to 50%, from 41% to 50%, from 42% to 50%, from 43% to 49%, or from 44% to 48%.

In yet another specific example, the total flavonoid content of the pear juice according to the present invention may be increased by 40%, 41%, 42%, 43%, 44%, 45%, 46%, 47%, 48%, 49%, 50%, or more compared to pear juice that has been heat-sterilized only and not subjected to steaming. The increase may also fall within a range defined by any two of the foregoing values, for example, from 40% to 50%, from 41% to 50%, from 42% to 50%, from 42% to 49%, from 42% to 48%, or from 42% to 47%.

Accordingly, when the pear juice according to the present invention is consumed as a beverage or used as an additive in processed foods, it exhibits excellent antioxidant activity, and consumption thereof can provide superior antioxidant benefits.

### Advantageous Effects

The pear juice prepared according to the present invention exhibits significantly enhanced antioxidant activity and increased total polyphenol and flavonoid contents compared to pear juice that has been heat-sterilized but not subjected to steaming. Accordingly, consumption of the pear juice according to the present invention can provide superior antioxidant benefits.

### DESCRIPTION OF THE DRAWINGS

The FIGURE is a schematic diagram illustrating a method for preparing pear juice according to one embodiment of the present invention.

### BEST MODE

Hereinafter, the present invention will be described in detail with reference to examples for better understanding. However, it should be understood that the examples according to the present invention may be modified in various forms, and the scope of the present invention is not limited to the following examples. The examples are provided merely to more fully illustrate the present invention to those skilled in the art.

### Manufacturing Example 1: Preparation of Pear Juice

Raw pears (Korean pears cultivated in Naju, Jeollanam-do, Republic of Korea) were bubble-washed to remove foreign substances and then crushed into 5 mm pieces using a crusher (manufactured by Deokwoo Machinery). The crushed pears were then pressed using a juicer (manufactured by Deokwoo Machinery) to obtain pear juice, which was subsequently filtered through a mesh filter with a pore diameter of 0.3 mm. The filtered juice was heat-sterilized at 85° C. for 3 hours, followed by filtration through a 100-mesh screen, and then packaged in pouch bags.

### Manufacturing Example 2: Preparation of Pear Juice

Pear juice was prepared in the same manner as in Manufacturing Example 1, except that after heat sterilization, the juice was steamed at 30° C. for 12 hours, then filtered through a 5 μm microfilter. The steamed juice was subsequently subjected to ultra-high temperature short-time sterilization at 121° C. for 40 seconds, followed by filtration through a 100-mesh screen, and then packaged in pouch bags.

### Manufacturing Example 3: Preparation of Pear Juice

Pear juice was prepared in the same manner as in Manufacturing Example 1, except that after heat sterilization, the juice was steamed at 65° C. for 12 hours, then filtered through a 5 μm microfilter. The steamed juice was subsequently subjected to ultra-high temperature short-time sterilization at 121° C. for 40 seconds, followed by filtration through a 100-mesh screen, and then packaged in pouch bags.

### Manufacturing Example 4: Preparation of Pear Juice

Pear juice was prepared in the same manner as in Manufacturing Example 1, except that after heat sterilization, the juice was steamed at 85° C. for 12 hours, then filtered through a 5 μm microfilter. The steamed juice was subsequently subjected to ultra-high temperature short-time sterilization at 121° C. for 40 seconds, followed by filtration through a 100-mesh screen, and then packaged in pouch bags.

### Example 1: Measurement of pH and Brix of Pear Juice

The pH and Brix (sugar content) of the pear juices prepared in Manufacturing Examples 1 to 4 were measured. Specifically, the pH and Brix were measured at room temperature using a pH meter (WTW inoLab® pH 7110) and a refractometer (ATAGO PAL-1), respectively, with each measurement repeated three times. As shown in Table 1 below, all pear juice samples exhibited similar pH and Brix values regardless of whether the steaming process was applied.

TABLE 1

| | Manufactruing | Manufactruing | Manufactruing | Manufactruing |
|---|---|---|---|---|
| | Example 1 | Example 2 | Example 3 | Example 4 |
| pH | 5.11 | 5.09 | 5.06 | 4.93 |
| Brix | 12.6 | 12.2 | 12.6 | 12.7 |

### Example 2: Analysis of Total Polyphenol and Flavonoid Contents in Pear Juice

### 2-1. Analysis of Total Polyphenol Content

A mixture was prepared by combining 200 μL each of 2% sodium carbonate solution, 10% Folin-Ciocalteu's phenol reagent, and the pear juice samples prepared in Manufacturing Examples 1 to 4. The mixtures were incubated at room temperature for 1 hour. After the reaction, the samples were centrifuged using a centrifuge (Smart-R17, 294×480×278 mm) at 12,000 rpm for 10 minutes. The supernatants were collected, and absorbance was measured three times at 700 nm using a spectrophotometer (Perkin Elmer, Waltham, MA, USA). Gallic acid was used as the standard, and a calibration curve was constructed using diluted standard solutions at various concentrations to quantify total polyphenol content.

As shown in Table 2 below, the pear juice from Manufacturing Example 4 exhibited the highest total polyphenol content, showing an increase of approximately 46% to 48% compared to the pear juice from Manufacturing Example 1.

TABLE 2

| | Total Phenolic Content |
|---|---|
| Pear juice | (Gallic Acid eq. μg/100 μg Extract) |
| Manufacturing Example 1 | 19.73 ± 0.38 |
| Manufacturing Example 2 | 17.07 ± 0.53 |
| Manufacturing Example 3 | 21.12 ± 0.09 |
| Manufacturing Example 4 | 29.02 ± 0.05 |

### 2-2. Analysis of Total Flavonoid Content

To each sample from Manufacturing Examples 1 to 4, 100 μL of 10% aluminum nitrate, 100 μL of 1 M potassium acetate, and 4.3 mL of 100% ethanol were added and mixed. The mixtures were allowed to react for 40 minutes. After the reaction, absorbance was measured at 415 nm using a spectrophotometer (Perkin Elmer, Waltham, MA, USA), with each measurement repeated three times. Quercetin was used as the standard substance, and a calibration curve was constructed using standard solutions diluted to various concentrations to determine the total flavonoid content.

As shown in Table 3 below, the pear juice from Manufacturing Example 4 exhibited the highest total flavonoid content, showing an increase of approximately 43% to 47% compared to the pear juice from Manufacturing Example 1.

TABLE 3

| | Total Flavonoid Content |
|---|---|
| Pear juice | (Quercetin eq. μg/100 μg Extract) |
| Manufacturing Example 1 | 13.14 ± 0.06 |
| Manufacturing Example 2 | 12.87 ± 0.03 |
| Manufacturing Example 3 | 15.22 ± 0.06 |
| Manufacturing Example 4 | 19.03 ± 0.06 |

### Example 3: Antioxidant Activity of Pear Juice

### 3-1. DPPH Radical Scavenging Activity

To evaluate the antioxidant activity of the prepared pear juices, 100 μL of 0.4 mM DPPH (Sigma-Aldrich, Saint Louis, MO, USA) was mixed with 100 μL of each pear juice sample from Manufacturing Examples 1 to 4. The mixtures were allowed to react in the dark for 30 minutes. Absorbance was then measured at 517 nm using a spectrophotometer (Perkin Elmer, Waltham, MA, USA), with each measurement repeated three times.

As shown in Table 4 below, the pear juice from Manufacturing Example 4 exhibited the highest DPPH radical scavenging activity, showing an increase of approximately 26% to 29% compared to the pear juice from Manufacturing Example 1.

TABLE 4

| Pear juice | DPPH radical scavenging activity (%) |
|---|---|
| Manufacturing Example 1 | 62.86 ± 0.42 |
| Manufacturing Example 2 | 46.59 ± 1.67 |
| Manufacturing Example 3 | 64.05 ± 1.04 |
| Manufacturing Example 4 | 80.32 ± 0.14 |

### 3-2. ABTS Radical Scavenging Activity

To measure the ABTS radical scavenging activity of the pear juices, an ABTS solution was prepared by reacting equal volumes of 7.4 mM ABTS and 2.6 mM potassium persulfate in the dark for 24 hours. Then, 100 μL of the resulting ABTS solution was mixed with 100 μL of each pear juice sample from Manufacturing Examples 1 to 4 and allowed to react for 10 minutes. Absorbance was measured at 734 nm using a spectrophotometer (Perkin Elmer, Waltham, MA, USA), with each measurement repeated three times. As shown in Table 5 below, the pear juice from Manufacturing Example 4 exhibited the highest ABTS radical scavenging activity, showing an increase of approximately 8% to 13% compared to the pear juice from Manufacturing Example 1.

TABLE 5

| Pear juice | ABTS radical scavenging activity (%) |
|---|---|
| Manufacturing Example 1 | 84.00 ± 0.56 |
| Manufacturing Example 2 | 56.00 ± 1.16 |
| Manufacturing Example 3 | 68.17 ± 0.69 |
| Manufacturing Example 4 | 92.47 ± 1.05 |

1. A method for preparing pear juice with enhanced antioxidant activity, the method comprising:
(S10) crushing raw pears including the peel and seeds;
(S20) pressing the crushed pears to separate only the juice;
(S30) heat-sterilizing the separated juice; and
(S40) steaming the heat-sterilized juice at a temperature of 80 to 90° C.

2. The method of claim 1, wherein the peel in step (S10) comprises an epicarp, mesocarp, and endocarp.

3. The method of claim 1, wherein the heat sterilization in step (S30) is performed at 80 to 90° C. for 2 to 4 hours.

4. The method of claim 1, wherein the steaming in step (S40) is performed for 10 to 14 hours.

5. The method of claim 1, wherein the pear juice with enhanced antioxidant activity has a total phenolic content and a total flavonoid content that are increased by 40 to 50%, respectively, compared to pear juice prepared through steps (S10) to (S30).

6. The method of claim 1, wherein the pear juice with enhanced antioxidant activity exhibits DPPH radical scavenging activity and ABTS radical scavenging activity that are increased by 20 to 30% and 8 to 13%, respectively, compared to pear juice prepared through steps (S10) to (S30).
